(19) United States
(12) Patent Application Publication
(10) Pub. No.: US 2023/0067751 A1
(43) Pub. Date: Mar. 2, 2023

(54) Methods and Systems for Controlling a Vehicle

(71) Applicant: Aptiv Technologies Limited, St. Michael (BB)

(72) Inventors: Sebastian Yousef, Bochum (DE); Christian Prediger, Lindlar (DE); Thorsten Rosenthal, Mulheim (DE); Mirko Meuter, Erkrath (DE)

(21) Appl. No.: 17/820,830

(22) Filed: Aug. 18, 2022

(30) Foreign Application Priority Data
Aug. 26, 2021 (EP) 21193256.1

(51) Int. Cl. B60W 30/18

(52) U.S. Cl. CPC B60W 30/18109; B60W 2510/18; B60W 2510/20

(57) ABSTRACT

The present disclosure describes a computer-implemented method for controlling a vehicle. In aspects, the computer-implemented method includes acquiring sensor data from a sensor, determining first processed data related to a first area around the vehicle based on the sensor data using a machine-learning method, and determining second processed data related to a second area around the vehicle based on the sensor data using a conventional method. The second area may include a subarea of the first area. In addition, the computer-implemented method includes controlling the vehicle based on the first processed data and the second processed data.

### INCORPORATION BY REFERENCE

This application claims priority to European Patent Application Number 21193256.1, filed Aug. 26, 2021, the disclosure of which is incorporated by reference in its entirety.

### BACKGROUND

Radar data processing is an essential task for autonomous or partially autonomous vehicles. Accordingly, there is a need for efficient radar data processing.

### SUMMARY

The present disclosure provides a computer-implemented method, a computer system, and a non-transitory computer readable medium according to the independent claims. Embodiments are given in the subclaims, the description and the drawings.

In one aspect, the present disclosure is directed at a computer-implemented method for controlling a vehicle, the method comprising the following steps performed (i.e., carried out) by computer hardware components: acquiring sensor data from a sensor; determining first processed data related to a first area around the vehicle based on the sensor data using a machine-learning method (e.g., an artificial neural network); determining second processed data related to a second area around the vehicle based on the sensor data using a conventional method, wherein the second area comprises (e.g., is) a subarea of the first area; and controlling the vehicle based on the first processed data and the second processed data.

In other words, a machine-learning method is applied to sensor data for vehicle control for an area around a vehicle, and a conventional (i.e., classical) method is applied to the same sensor data for the vehicle control for a part of the area.

It has been found that the machine-learning method may provide efficient results for a large area, while the conventional method may provide reliable and legally appropriate detections. The conventional method may not be using machine-learning. For example, the method may provide a machine-learning implementation of radar-based occupancy grid vehicle safety systems, for example radar detection with machine-learning supported occupancy grid.

According to an embodiment, the conventional method double-checks the first processed data. The conventional method may provide safety relevant detections and may confirm detections of the machine-learning method. According to an embodiment, the conventional method double-checks the first processed data along a target trajectory of the vehicle. Objects along the trajectory may be particularly relevant for controlling the vehicle. According to an embodiment, double-checking comprises determining an energy in radar data related to a position of an object determined based on the first processed data (e.g., using the conventional method). It has been found that objects determined by the machine-learning method may be verified by determining an energy of radar detections using the conventional method.

According to an embodiment, the first processed data and the second processed data are determined in parallel. For example, the machine-learning method and the conventional method may be implemented on different hardware components, so that they may be carried out concurrently.

According to an embodiment, controlling the vehicle comprises controlling braking of the vehicle (e.g., controlling a brake of the vehicle or a recuperation module of the vehicle).

According to an embodiment, wherein if an object detected based on first processed data is confirmed based on second processed data, controlling the vehicle comprises comfort braking of the vehicle. Comfort braking may be comfortable for the passengers of the vehicle, and comfort braking in this situation may be sufficient since the object was determined based on the machine-learning method and based on the larger area already.

According to an embodiment, wherein if an object detected based on first processed data is not confirmed based on second processed data, controlling the vehicle comprises not initiating braking of the vehicle. The conventional method may provide the final determination whether an object is present or not, and if an object is not present along the trajectory of the vehicle, breaking may not be required.

According to an embodiment, if an object undetected based on first processed data is detected based on second processed data, controlling the vehicle comprises emergency braking of the vehicle. Emergency braking may be braking at a deceleration as high as possible taking into account the condition of the vehicle and the road. Emergency braking in this situation may be required since the object only was detected in the smaller area by the conventional method.

According to an embodiment, the first area and/or the second area are/is determined based on a velocity of the vehicle. According to an embodiment, the first area and/or the second area are/is determined based on a steering angle of the vehicle. Depending on the velocity of the vehicle and/or the steering angle of the vehicle, different areas may be relevant for the control of the vehicle. For example, if the vehicle is driving faster, an area farther away may be relevant; for example, if the vehicle is turning to the left, and area towards the left of the vehicle may be relevant.

According to an embodiment, the sensor comprises at least one of a radar sensor, a light detection and ranging (LIDAR) sensor, an infrared sensor, or a camera. It will be understood that although various embodiments are described herein with reference to radar data, various other kinds of sensors may be used.

In another aspect, the present disclosure is directed at a computer system, said computer system comprising a plurality of computer hardware components configured to carry out several or all steps of the computer-implemented method described herein. The computer system can be part of a vehicle.

The computer system may comprise a plurality of computer hardware components (e.g., a processor, for example processing unit or processing network, at least one memory, for example memory unit or memory network, and at least one non-transitory data storage). It will be understood that further computer hardware components may be provided and used for carrying out steps of the computer-implemented method in the computer system. The non-transitory data storage and/or the memory unit may comprise a computer program for instructing the computer to perform several or all steps or aspects of the computer-implemented method described herein, for example using the processing unit and the at least one memory unit.

In another aspect, the present disclosure is directed at a vehicle, comprising the computer system as described herein and the sensor.

In another aspect, the present disclosure is directed at a non-transitory computer readable medium comprising instructions for carrying out several or all steps or aspects of the computer-implemented method described herein. The computer readable medium may be configured as: an optical medium, such as a compact disc (CD) or a digital versatile disk (DVD); a magnetic medium, such as a hard disk drive (HDD); a solid state drive (SSD); a read only memory (ROM), such as a flash memory; or the like. Furthermore, the computer readable medium may be configured as a data storage that is accessible via a data connection, such as an internet connection. The computer readable medium may, for example, be an online data repository or a cloud storage.

The present disclosure is also directed at a computer program for instructing a computer to perform several or all steps or aspects of the computer-implemented method described herein.

According to various embodiments, object perception with the use of both classical algorithms for AEB (autonomous emergency braking) functions and machine-learning model-based approaches may be provided. Various embodiments may provide a rearrangement of computation intensive M/L and model based method together with safety-critical braking algorithms, may close the gap of non-existing safe and secure M/L based methods for autonomous drive, may decrease computation effort by processing only trajectory relevant radar data with classical DFT algorithm, and/or may provide object detection, classification as well as extraction of further important information like poses and gestures which cannot be processed by classical occupancy grid methods alone.

### BRIEF DESCRIPTION OF THE DRAWINGS

Example embodiments and functions of the present disclosure are described herein in conjunction with the following drawings, showing schematically:

FIG. 1 is an illustration of process flow to occupancy grid;

FIG. 2 is a flow diagram of data processing according to various embodiments;

FIG. 3 is an illustration of a situation with a straight (i.e., linear) trajectory according to various embodiments;

FIG. 4 is an illustration of a situation with a curved trajectory according to various embodiments;

FIG. 5 is an illustration of data flow on ECU system level according to various embodiments;

FIG. 6 is a flowchart illustration a method flow with confirmation logic according to various embodiments;

FIG. 7 is an illustration of normal system behavior according to various embodiments;

FIG. 8 is an illustration of false positive perception according to various embodiments;

FIG. 9 is an illustration of false negative perception according to various embodiments;

FIG. 10 is a flow diagram illustrating a method for controlling a vehicle according to various embodiments; and

FIG. 11 is a computer system with a plurality of computer hardware components configured to carry out steps of a computer-implemented method for controlling a vehicle according to various embodiments.

### DETAILED DESCRIPTION

For assisted driving, automated driving, and autonomous driving, it may be desired for the vehicle to perceive its surroundings and recognize dynamic and static objects. Object detection and recognition may be done by several sensor systems of the car simultaneously. In the following, example embodiments will be provided for radar sensors; however, it will be understood that other kinds of sensors (e.g., lidar sensors, cameras) may be used.

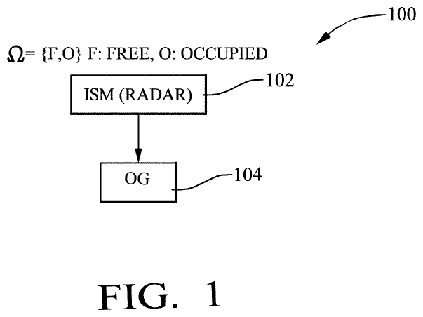

FIG. 1 shows an illustration 100 of process flow to occupancy grid. Sensor data may be acquired from radar sensors, and the sensor data may be filtered, for example by a constant false alarm rate (CFAR) method and, afterwards, may be processed with a so called Inverse Sensor Model (ISM) 102 to compute qualitative information of the environment. A virtual 2-dimensional grid may be imagined to input probability of occupied or free areas; this grid may be referred to as occupancy map or occupancy grid (OG) 104. The ISM 102 may be represented by the conditional probability of occupancy of each cell (of the OG 104), whereas cells are independent from each other.

The sensor data (i.e., perception data) may be filtered with classical filters (e.g., a Gaussian filter, a Bayesian filter) and methods that may be mainly blind to certain detections of objects that are from smaller dimension or farther away. Due to the problem that radar detections may be suffering of noise factors, the fetched data streams may have to be filtered out to hand them over to classical methods. This may erase important information which could be used for more performant object detection, though.

According to various embodiments, a combination of various processing branches may be provided which allows deploying a machine-learning based perception technology, which may deliver better characteristics and has superiority over classical radar processing, object detection and tracking. The target hereby may be to use the machine-learning technology not only as input for comfort functionality but also for safety relevant driving decisions. Safety in this context may mean that such a system may allow to argue a safety case with respect to the state of the art required ISO 26262. According to various embodiments, all this may be done without the need of following the ISO development processes and the fulfillment of hard to achieve elements like explainability for the immanent machine-learning method part itself. Thereby, various embodiments may overcome the contradiction that a superior technology of machine-learning (which may deliver much higher recognition quality and by this in the end may prevent many risky situations) is by design not applicable in many systems without the increased effort of software development aligned to ISO 26262.

In terms of the ISO 26262, the methods according to various embodiments may match a decomposition in a queue management (QM) path (which may be handled by a machine-learning (M/L) method) and an automotive safety integrity level (ASIL) B path (which may be provided by a conventional method and which may initiate comfort and emergency braking). Under the assumption that the radar data stream from the radar was also generated in ASIL B, quality the overall path for the radar (from the sensor to the objects) may achieve an ASIL B.

Various embodiments may provide methods for processing radar data with minimal efforts of safety qualification, while at the same time provide highly efficient processing and computing performance. Furthermore, the combination and synergy between classical methods (i.e., methods which are free from machine-learning methods) and machine-learning methods (e.g., artificial neural networks) may lower possible systematic failures.

Various embodiments may furthermore overcome the disadvantage of the need to filter out low energy/low threshold radar detections to be able to provide them to a classical but still safer processing method.

Various embodiments may use two independent paths of processing filled with the same radar data stream.

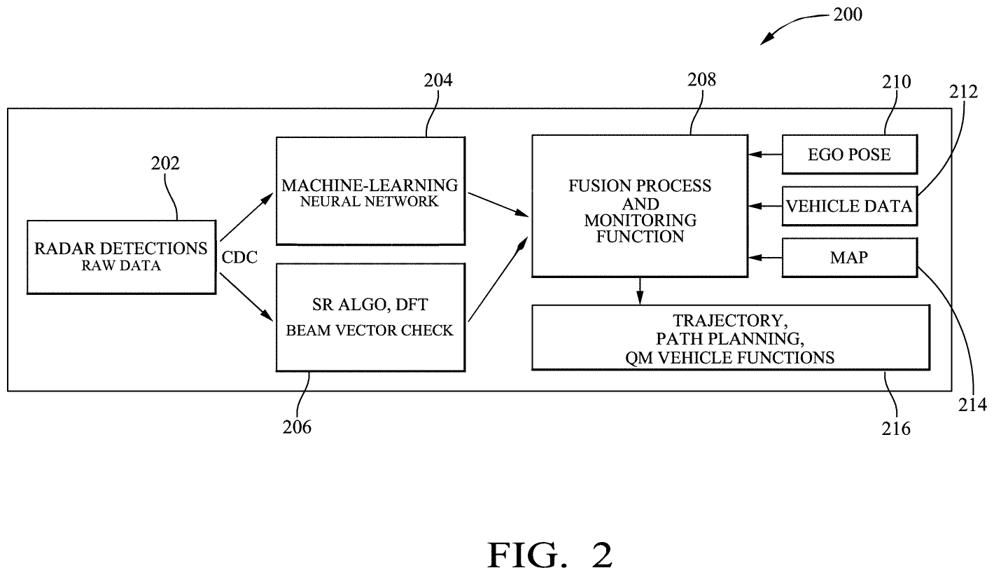

FIG. 2 shows a flow diagram 200 of data processing according to various embodiments. Radar detections raw data 202 may be provided to two processing branches. The radar detections raw data 202 may be provided as an input radar data stream. Receptions by an antenna array may be stacked and be added to the radar data stream. A data interface may be defined to transfer data from the range, range-rate maps from each antenna at selected range range-rate points. Especially locations, where the energy in an integrated energy map over all antennas is above CFAR and forms a local maximum, may be transferred, as this data may be used to form a detection in classical processing. However, more datapoints may be transferred to improve performance.

A first processing branch 204 may include a machine-learning method (e.g., an artificial neural network) for, as an example, radar raw data processing. A second processing branch 206 may include a short range (SR) method or a discrete Fourier transform (DFT) method and may include a beam vector check. The second processing branch may be referred to as “classic method” and may be free from (i.e., may not include) machine-learning methods. The first processing branch 204 may provide first processed data to a fusion process and monitoring function 208. The second processing branch 206 may provide second processed data to the fusion process and monitoring function 208. The fusion process and monitoring function 208 may perform enhanced occupancy grid detections (e.g., using machine-learned detections), for example including an ego pose 210, vehicle data 212, or a map 214 as further input, and may provide output data for controlling the vehicle to a module 216, which may for example determine a trajectory, carry out path planning, and/or QM vehicle functions.

For both processing streams (i.e., branches), such as the first processing branch 204 and the second processing branch 206, the same radar data may be used. The classical stream (i.e., the second processing branch 206) may filter out noise factors and artefacts e.g., by CFAR and the following Inverse Sensor Model (ISM) may dictate how the given measurements affect the occupancy states then. An integrated Bayesian filtering may determine how cell occupancy is updated over temporal samples. This virtual grid may be applied by the attached fusion process.

The first processing stream (i.e., the first processing branch 204) may receive the same radar data as the second processing branch 206 and may perform the raw data processing in a different manner. The first processing branch 204 may use machine-learning method, for example a previously trained (artificial) neural network.

Machine learning method specialized to processing of radar raw data may find out much more detailed objects for perception and may additionally be able to perform a kind of object imaging in the farther environment of the ego vehicle.

The artificial neural network using in the first branch 204 may output its detections, which then may be imported to the fusion process building block 208.

The same radar data that is provided to the first branch 204 may also be provided to the second branch 206 and may be processed by a DFT method for angle finding and beam vector check based on received energy reflections and may perceive existing objects in the closer area.

The processing of the first branch 204 and of the second branch 206 may be carried out in parallel or sequentially.

According to various embodiments, computational requirements may be reduced by only detecting objects within the trajectory of ego vehicle; this may be used for comfort braking situations and/or emergency braking situations.

To find the relevant occupancy grid area in front of vehicle to be scanned for dynamic and static objects, trajectory data of driving situation may be taken into account and perception data may be varied accordingly.

According to various embodiments, trajectory related radar detections may be recalculated.

Let A define the DFT matrix transforming antenna array information into an angle dependent energy spectrum such that Fa=A*f_a.

Then the spectrum value at a specific angle k is given as F(k)=A(k)*f_a. A method for recalculation would be the calculation of the spectral energy values at specific angles k where the k values match to the angular position of the planned path at a specific distance.

Then the spectrum value at a specific angle k is given as F(a=k)=A(k)*f_a.

According to various embodiments, a main perception may take place by the use of machine-learning and model-based approach incorporated in a first area. This may be beneficial for smaller and hard to perceive objects, and may provide increased radar sensor performance not only for detecting but also for classifying and extracting detailed features like motion detection, poses and gestures. Accelerated machine-learning methods may be provided by systems-on-a-chip (SoCs) for artificial neural net computation (e.g., digital signal processors (DSPs)).

According to various embodiments, safety critical (e.g., related to ASIL) perception may take place within a smaller area. This may provide a decreased computational effort on non-parallelized methods. Thus, safe and secure execution of safety relevant decisions, for example braking functions or lane change, may be provided.

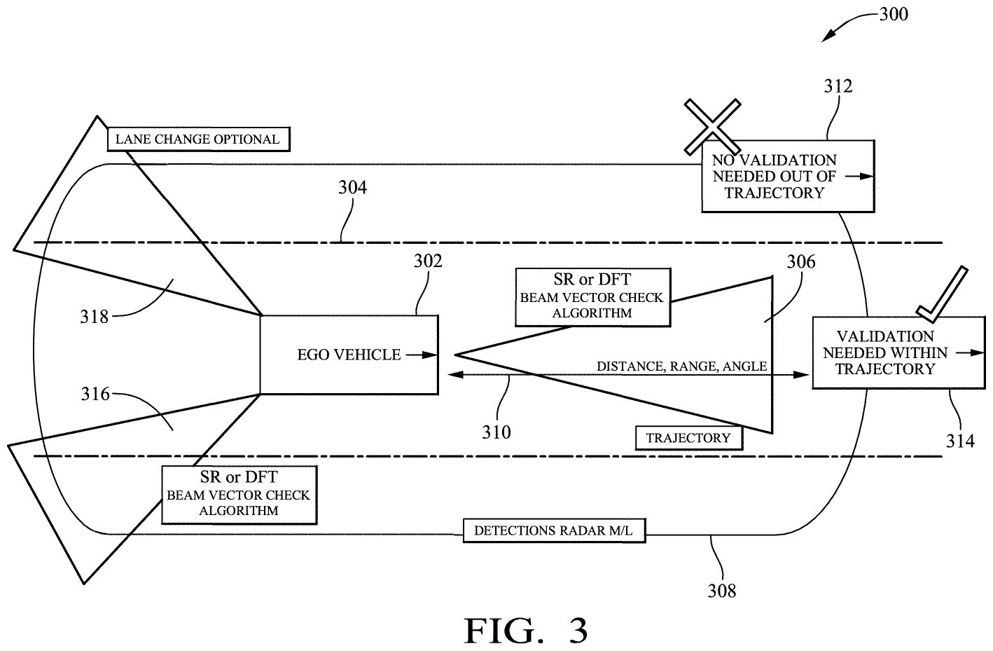

FIG. 3 shows an illustration 300 of a situation with a straight (i.e., linear) trajectory according to various embodiments. An ego vehicle 302 may be driving on a road 304. For example, another vehicle (not shown in FIG. 3) may be driving in front of the ego vehicle. Radar detections using machine-learning may be provided in a first area 308. Radar detections using classical methods may be provided in smaller areas 306, 316, 318. Depending on the distance, range, and angle (like indicated by arrow 310), it may be decided whether detections by the machine-learning method need to be verified by the classical methods. Detections which are along (or within) the target trajectory of the vehicle may be needed to be checked (e.g., a detection related to a possible object 314). Detections which are not along the target trajectory of the vehicle may not be needed to be checked (e.g., a detection related to a possible object 312). For example, in area 306 in front of the ego vehicle 302 (where another vehicle is driving), a classical method (e.g., SR or DFT) may be applied (e.g., to double-check the results obtained by the machine-learning method). Likewise, in area 316 at the right back area of the ego vehicle 302, the classical method may be applied. In area 318, which may be relevant if the ego vehicle 302 would consider a lane change, the classical method may be applied.

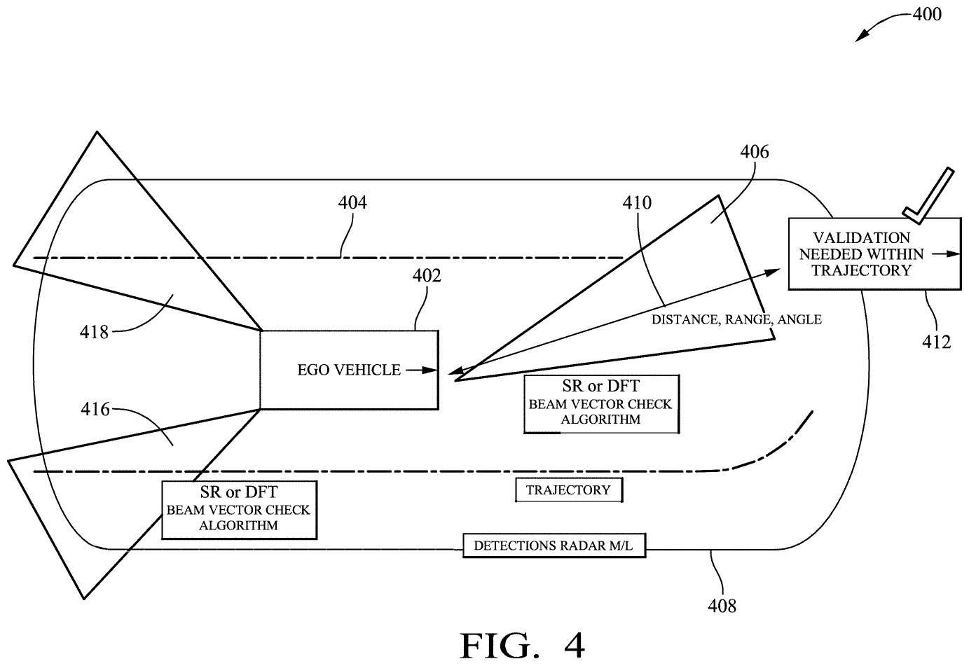

FIG. 4 shows an illustration 400 of a situation with a curved trajectory according to various embodiments. An ego vehicle 402 may be driving on a road 404. For example, another vehicle (not shown in FIG. 4) may be driving in front of the ego vehicle. Radar detections using machine-learning may be provided in a first area 408. Radar detections using classical methods may be provided in a smaller area 406. Depending on the distance range, and angle (like indicated by arrow 410), it may be decided whether detections by the machine-learning method need to be verified by the classical methods. Detections which are along (or within) the target trajectory of the vehicle may be needed to be checked (e.g., a detection related to a possible object 412). Detections which are not along the target trajectory of the vehicle may not be needed to be checked. For example, in area 406 in front of the ego vehicle 402 (where another vehicle is driving), a classical method (e.g., SR or DFT) may be applied (e.g., to double-check the results obtained by the machine-learning method). Likewise, in area 416 at the right back area of the ego vehicle 402, the classical method may be applied. In area 418, which may be relevant if the ego vehicle 402 would consider a lane change, the classical method may be applied.

Classical Fast Fourier Transform (FFT) methods may be executed on ASIL-B performance SoC for the trajectory specific area and may compare the M/L (machine-learning) based detections. The Path-planning and braking decisions may always be directed by the FFT methods to delete false positive and false negative detections, for example like illustrated in the following.

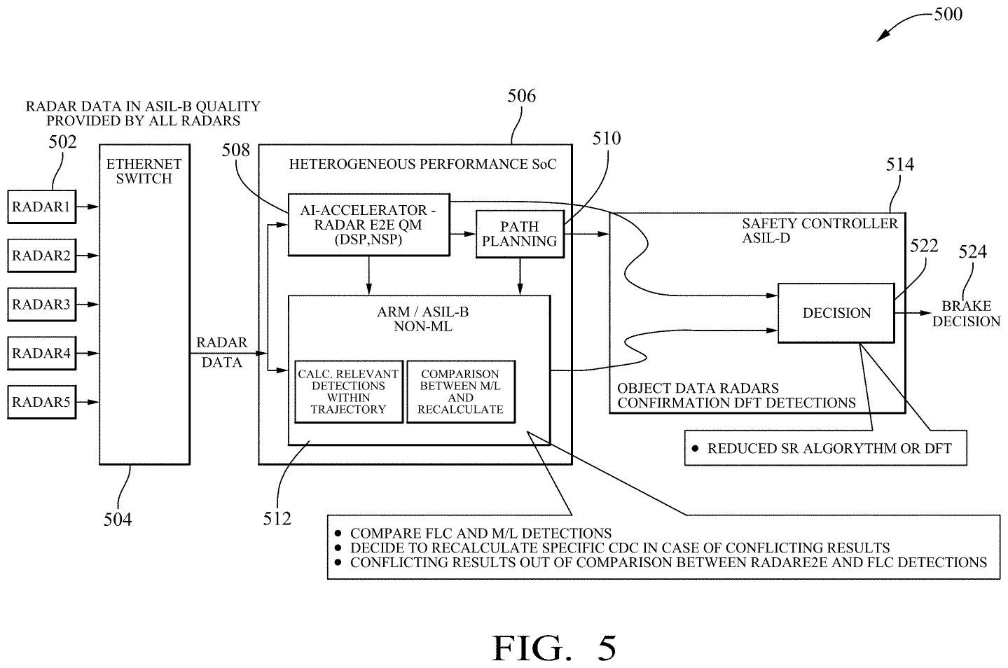

FIG. 5 shows an illustration of data flow on ECU (electronic control unit) system level according to various embodiments. Various radar sensors 502 may provide data to an ethernet switch 504, which may output data to a heterogenous performance SoC 506, which may include an AI (artificial intelligence) accelerator 508 and a ASIL-B scalar processing unit 512 (which may compare FLC (forward looking camera) and machine-learning detections, may decide to recalculate specific radar data in case of conflicting results, and may determine conflicting results out of comparison between machine-learning methods and classical methods.

The machine-learning method 508 may provide data to a path planning block 510, which may provide its output data to a safety controller 514.

The ASIL-B scalar processing unit 512 may output object data radars to the ASIL-D safety controller 514, which, in a decision block 522 may fuse machine-learning detections and detections from a classical method. The decision block 522 may determine a brake decision 524.

As illustrated in FIG. 5, ASIL decomposition may be provided via, for example, machine-learning in QM (block 508) and/or a non-M/L approach (i.e., classical approach) in ASIL B or higher (block 512).

The machine-learning method of block 508 may find more objects with higher detail level, may provide object imaging, and may determine stationary and dynamic objects.

The classical approach of block 512 may (1) provide second FFT angle finding, (2) provide a superresolution method, and may determine less objects and may provide less range, but may be validated and safe.

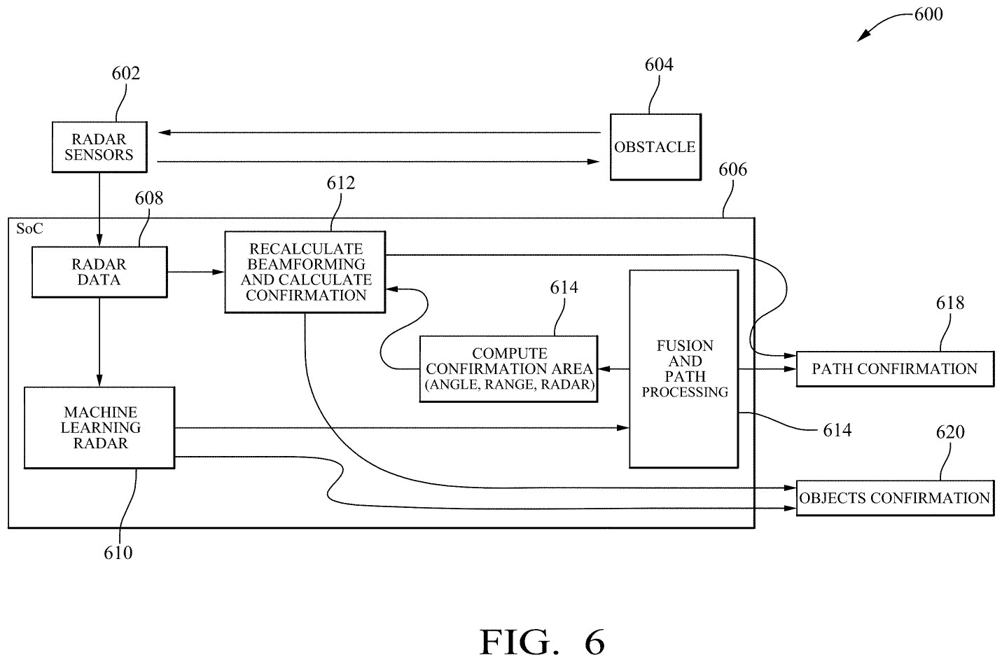

FIG. 6 shows a diagram 600 illustrating a method flow with confirmation logic according to various embodiments. A radar sensor 602 may sense an obstacle 604 and may provide radar data 608 to a SoC 606. The radar data 608 may be provided to a machine-learning method 610 and to a classical method 612 (e.g., a superresolution method). The classical method 612 may include a DFT (discrete Fourier transform). The classical method 612 may recalculate beamforming and may calculate a confirmation.

Given that a system, e.g., the M/L system 610, has detected a certain target in a certain distance and in a certain speed range, the energy in this area may be calculated for specific beam vectors using classical superresolution methods 612, or a DFT. An efficient solution may be the calculation of energy within certain angular bins.

For example, a DFT may be formulated as complex matrix multiplication s=A*x where a specific bin s(α) allows to derive energy for a specific angle α, e.g., by simplifying the equation to s(α)=A(α)x where A(α) represents a specific line in matrix A.

Given that a target represents reflections in certain range angle bins in a defined speed range, it may be looked for maxima within a range around the target with a specific energy to crosscheck for physical evidence for a target at that range.

On the opposite, a path may also be checked where each x,y cell represents a certain range angle area in a radar data cube by summing over the energy for a specific angle over all doppler bins in the specific range bin to look for evidence of a target in the cell or close to the cell. Any indication of energy belonging to a target in a specific beamvector may be crosschecked with an SR method on that specific beamvector to save calculation time.

For example, in block 614, a check for trajectory-relevant angle bins for energy maxima may be carried out, and a crosscheck for physical evidence of the obstacle may be carried out. In block 614, a confirmation area (e.g., related to angle, range, radar) may be determined.

The output of the machine-learning method 610 and the result of cross check 614 may be provided as compiled object data 616 (e.g., based on fusion and path processing), and may be provided to a safety microcontroller unit (MCU), for example as a path confirmation 618. Objects confirmation 620 may be determined based on blocks 610 and 612.

Block 610 may be based on a machine-learning method. Blocks 612 and 614 may be based on a conventional method (i.e., classical method), and may be free from machine-learning methods.

According to various embodiments, the trajectory check may include a threat area which is based on nearby spatial area. Time-to-collision (TTC) may be determined based on ego and object trajectories, headway in forward ego path, and possible other threat reachable states based on reasonable physical limits.

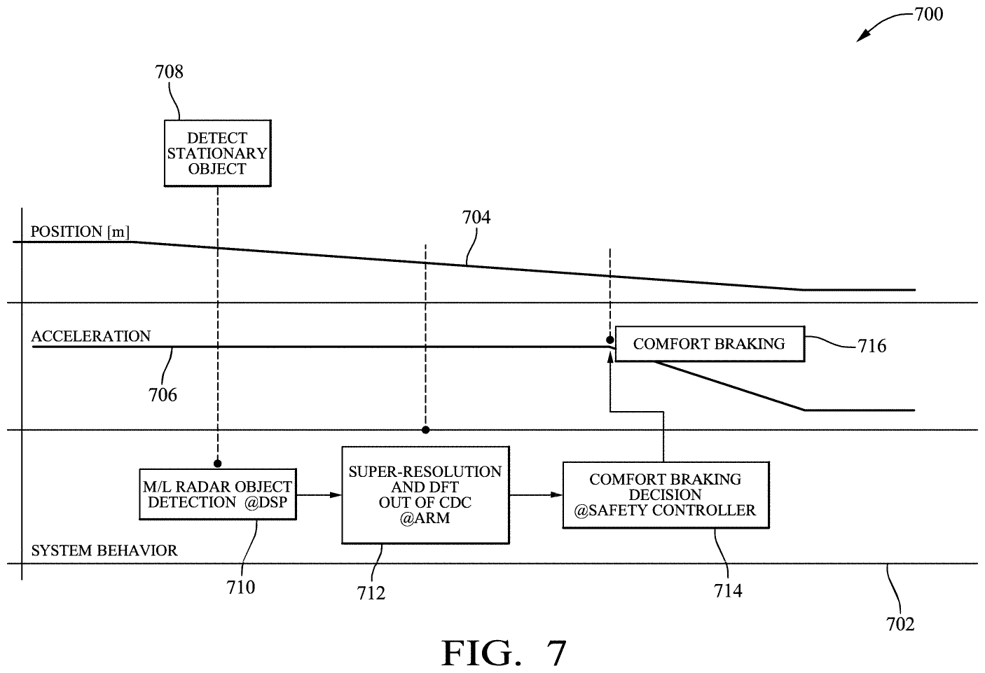

FIG. 7 shows an illustration 700 of normal system behavior according to various embodiments. A position 704 of a vehicle and an acceleration 706 of the vehicle are illustrated over time 702. A static object 708 may be detected by the machine-learning method 710. A classical method 712 may double-check and confirm the detection of the machine-learning method 710, and may take a comfort braking decision 714, so that comfort braking 716 may be initiated for the vehicle.

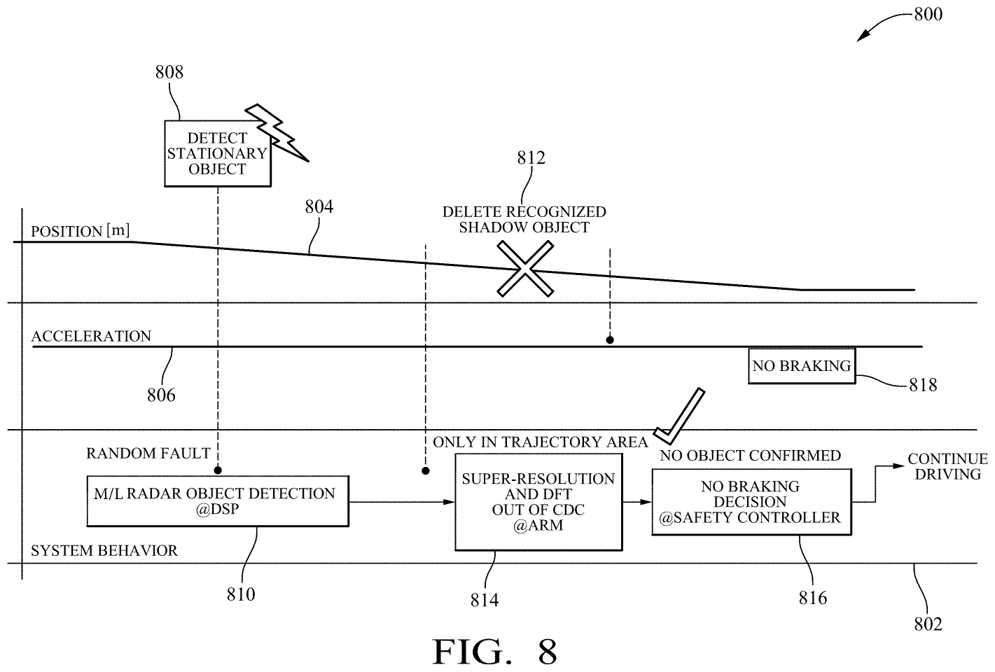

FIG. 8 shows an illustration 800 of false positive perception according to various embodiments. A position 804 of a vehicle and an acceleration 806 of the vehicle are illustrated over time 802. A shadow object 808 (i.e., an object which actually is non-existent) may be detected by the machine-learning method 810. A classical method 814 may double-check the detection of the machine-learning method 810 and may thus delete the recognized shadow object as illustrated in 812 (i.e., the shadow object may be disregarded). Thus, no braking decision may be taken, as illustrated in 816, so that no braking is initiated for the vehicle, as illustrated in 818.

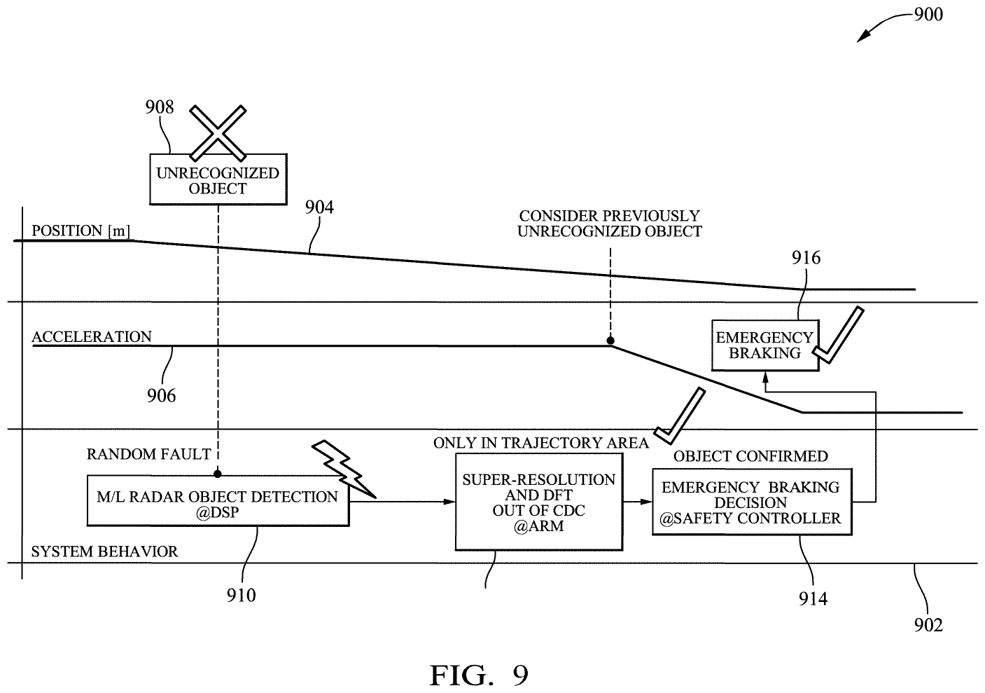

FIG. 9 shows an illustration 900 of false negative perception according to various embodiments. A position 904 of a vehicle and an acceleration 906 of the vehicle are illustrated over time 902. An object 908 may stay undetected by a machine-learning method 910. A classical method 912 may double-check an area along a trajectory of the vehicle, and may identify the previously unrecognized object 908. Thus, an emergency braking decision 914 may be taken, and emergency braking 916 may be initiated for the vehicle.

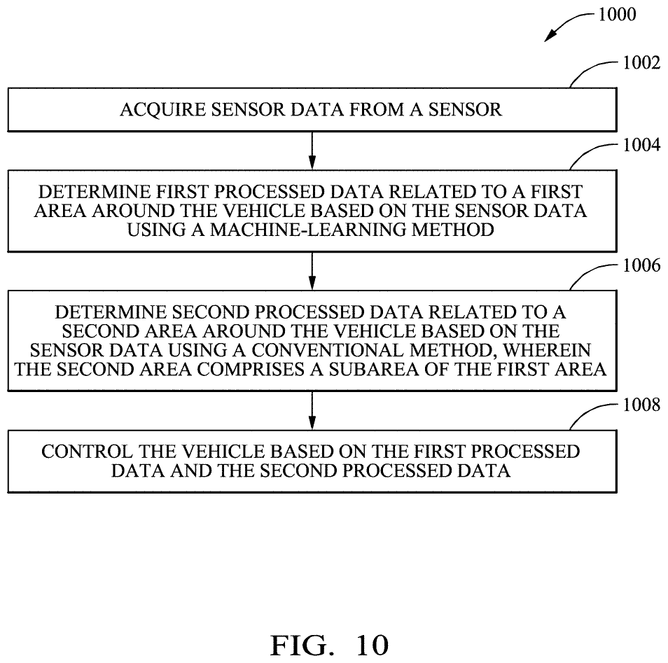

FIG. 10 shows a flow diagram 1000 illustrating a method for controlling a vehicle according to various embodiments. At 1002, sensor data may be acquired from a sensor. At 1004, first processed data related to a first area around the vehicle may be determined based on the sensor data using a machine-learning method. At 1006, second processed data related to a second area around the vehicle may be determined based on the sensor data using a conventional method, wherein the second area includes (e.g., is) a subarea of the first area. At 1008, the vehicle may be controlled based on the first processed data and the second processed data.

According to various embodiments, the conventional method may perform double-checking of the first processed data.

According to various embodiments, the conventional method may perform double-checking of the first processed data along a target trajectory of the vehicle.

According to various embodiments, double-checking may include or may be determining an energy in radar data related to a position of an object determined based on the first processed data.

According to various embodiments, the first processed data and the second processed data may be determined in parallel.

According to various embodiments, controlling the vehicle may include or may be controlling braking of the vehicle.

According to various embodiments, if an object detected based on first processed data is confirmed based on second processed data, controlling the vehicle may include or may be comfort braking of the vehicle.

According to various embodiments, if an object detected based on first processed data is not confirmed based on second processed data, controlling the vehicle may include or may be not initiating braking of the vehicle.

According to various embodiments, if an object undetected based on first processed data is detected based on second processed data, controlling the vehicle may include or may be emergency braking of the vehicle.

According to various embodiments, the first area and/or the second area may be determined based on a velocity of the vehicle.

According to various embodiments, the first area and/or the second area may be determined based on a steering angle of the vehicle.

According to various embodiments, the sensor may include or may be one or more radar sensors and/or one or more lidar sensors and/or one or more infrared sensors and/or one or more cameras. Each of the steps 1002, 1004, 1006, 1008 and the further steps described above may be performed by computer hardware components.

With the methods and systems as described herein, unintended braking on system limit may be prevented (e.g., by identifying or avoiding false positives). Objects from outer area may be crosschecked with the objects of the inner area. If an object is not confirmed at the transition from outer to inner area, no autonomous emergency braking (AEB) will be triggered.

With the methods and systems as described herein, insufficient braking may be prevented (e.g., by identifying or avoiding false negatives). Objects from outer area may be crosschecked with the objects of the inner area. If an object appears in inner area that is not known from outer area, AEB will be triggered anyhow.

With the methods and systems as described herein, path planning and trajectory generation may be based on the ML objects and such on the best possible environmental model.

With the methods and systems as described herein, path planning and trajectory generation may be done in a deterministic, ASIL certified method. As long as the input to this method is correct, it can be assumed that the output is correct.

Failures in the input may be detected and covered with the measures described herein.

As described herein, radar perception may be using CFAR method for filtering incoming reflections to avoid artefacts and an inverse sensor model may be used for post-processing to calculate qualitative information of environment. Radar detections may be suffering of noise factors, so that input stream may be filtered to be processed (however, this filtering may erase important information which could be valuable for detailed detections). Thus, according to various embodiments, a combination of techniques may be provided to allow machine-learning based perception. Various embodiments may deliver better characteristics and superiority over classical radar processing. According to various embodiments, a combination between a classical method and an artificial neural network may lead to lower systematic failure with ASIL-B Quality. According to various embodiments, no high validation and testing effort for M/L based method may be required, and safety related parts may still be realized with known and existing methods on an ASIL-B processor.

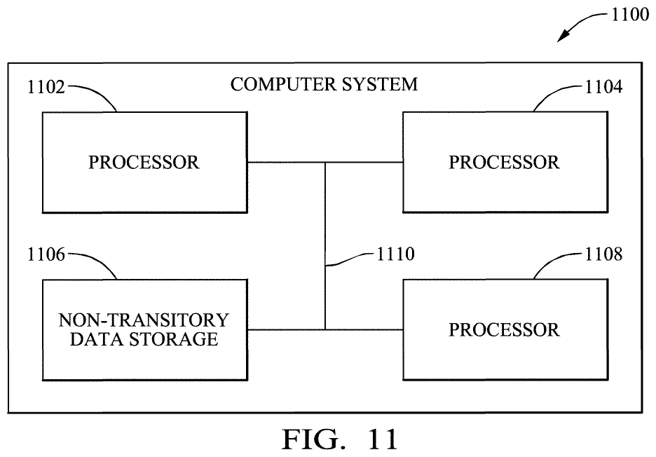

FIG. 11 shows a computer system 1100 with a plurality of computer hardware components configured to carry out steps of a computer-implemented method for controlling a vehicle according to various embodiments. The computer system 1100 may include a processor 1102, a memory 1104, and a non-transitory data storage 1106. A sensor 1108 may be provided as part of the computer system 1100 (like illustrated in FIG. 11) or may be provided external to the computer system 1100.

The processor 1102 may carry out instructions provided in the memory 1104. The non-transitory data storage 1106 may store a computer program, including the instructions that may be transferred to the memory 1104 and then executed by the processor 1102. The sensor 1108 may be used to acquire the sensor data as described herein.

The processor 1102, the memory 1104, and the non-transitory data storage 1106 may be coupled with each other, e.g., via an electrical connection 1110, such as e.g., a cable or a computer bus or via any other suitable electrical connection to exchange electrical signals. The sensor 1108 may be coupled to the computer system 1100, for example via an external interface, or may be provided as parts of the computer system (i.e., internal to the computer system, for example coupled via the electrical connection 1110).

The terms “coupling” or “connection” are intended to include a direct “coupling” (e.g., via a physical link) or direct “connection” as well as an indirect “coupling” or indirect “connection” (e.g., via a logical link), respectively.

It will be understood that what has been described for one of the methods above may analogously hold true for the computer system 1100.

### LIST OF REFERENCE CHARACTERS FOR THE ELEMENTS IN THE DRAWINGS

The following is a list of the certain items in the drawings, in numerical order. Items not listed in the list may nonetheless be part of a given embodiment. For better legibility of the text, a given reference character may be recited near some, but not all, recitations of the referenced item in the text. The same reference number may be used with reference to different examples or different instances of a given item.
100 illustration of process flow to occupancy grid
102 Inverse Sensor Model
104 occupancy grid
200 flow diagram of data processing according to various embodiments
202 radar detections raw data
204 first processing branch
206 second processing branch
208 fusion process and monitoring function
210 ego pose
212 vehicle data
214 map
216 module
300 illustration of a situation with a straight trajectory according to various embodiments
302 ego vehicle
304 road
306 smaller area
308 first area
310 arrow
312 possible object
314 possible object
316 smaller area
318 smaller area
400 illustration of a situation with a curved trajectory according to various embodiments
402 ego vehicle
404 road
406 smaller area
408 first area
410 arrow
412 possible object
416 area
418 area
500 illustration of data flow on ECU system level according to various embodiments
502 radar sensors
504 ethernet switch
506 heterogenous performance SoC
508 artificial intelligence accelerator
510 path planning block
512 ASIL-B scalar processing unit
514 safety controller
522 decision block
524 brake decision
600 diagram illustrating a method flow with confirmation logic according to various embodiments
602 radar sensor
604 obstacle
606 SoC
608 radar data
610 machine-learning method
612 classical method
614 block
616 compiled object data
618 path confirmation
620 objects confirmation
700 illustration of normal system behavior according to various embodiments
702 time
704 position
706 acceleration
708 static object
710 machine-learning method
712 classical method
714 comfort braking decision
716 comfort braking
800 illustration of false positive perception according to various embodiments
802 time
804 position
806 acceleration
808 shadow object
810 machine-learning method
812 shadow object is disregarded
814 classical method
816 no braking decision is taken
818 no braking is initiated
900 illustration of false negative perception according to various embodiments
902 time
904 position
906 acceleration
908 object
910 machine-learning method
912 classical method
914 emergency braking decision
916 emergency braking
1000 flow diagram illustrating a method for controlling a vehicle according to various embodiments
1002 step of acquiring sensor data from a sensor
1004 step of determining first processed data related to a first area around the vehicle based on the sensor data using a machine-learning method
1006 step of determining second processed data related to a second area around the vehicle based on the sensor data using a conventional method
1008 step of controlling the vehicle based on the first processed data and the second processed data
1100 computer system according to various embodiments
1102 processor
1104 memory
1106 non-transitory data storage
1108 sensor
1110 connection

What is claimed is:

1. A computer-implemented method for controlling a vehicle, the computer-implemented method comprising:
acquiring sensor data from a sensor;
determining first processed data related to a first area around the vehicle based on the sensor data using a machine-learning method;
determining second processed data related to a second area around the vehicle based on the sensor data using a conventional method, wherein the second area comprises a subarea of the first area; and
controlling the vehicle based on the first processed data and the second processed data.

2. The computer-implemented method of claim 1, wherein the conventional method double-checks the first processed data.

3. The computer-implemented method of claim 2, wherein the conventional method double-checks the first processed data along a target trajectory of the vehicle.

4. The computer-implemented method of claim 2, wherein double-checking comprises determining an energy in radar data related to a position of an object determined based on the first processed data.

5. The computer-implemented method of claim 1, wherein the first processed data and the second processed data are determined in parallel.

6. The computer-implemented method of claim 1, wherein controlling the vehicle comprises controlling braking of the vehicle.

7. The computer-implemented method of claim 1, wherein if an object detected based on first processed data is confirmed based on second processed data, controlling the vehicle comprises comfort braking of the vehicle.

8. The computer-implemented method of claim 1, wherein if an object detected based on first processed data is not confirmed based on second processed data, controlling the vehicle comprises not initiating braking of the vehicle.

9. The computer-implemented method of claim 1, wherein if an object undetected based on first processed data is detected based on second processed data, controlling the vehicle comprises emergency braking of the vehicle.

10. The computer-implemented method of claim 1, wherein at least one of the first area or the second area are determined based on a velocity of the vehicle.

11. The computer-implemented method of claim 1, wherein at least one of the first area or the second area are determined based on a steering angle of the vehicle.

12. The computer-implemented method of claim 1, wherein the sensor comprises at least one of a radar sensor, a light detection and ranging (LIDAR) sensor, an infrared sensor, or a camera.
